(19) United States
(12) Patent Application Publication
(10) Pub. No.: US 2017/0277187 A1
(43) Pub. Date: Sep. 28, 2017

(54) Aerial Three-Dimensional Scanner

(71) Applicant: Optecks, LLC, Bixby, OK (US)

(72) Inventors: Hakki H. Refai, Bixby, OK (US); Badia Koudsi, Bixby, OK (US)

(21) Appl. No.: 15/445,382

(22) Filed: Feb. 28, 2017

Related U.S. Application Data
(60) Provisional application No. 62/301,268, filed on Feb. 29, 2016.
(60) Provisional application No. 62/384,386, filed on Sep. 7, 2016.

(51) Int. Cl. G05D 1/00; H04N 7/18; G05D 1/10; G01S 17/89; B64C 39/02; B64D 47/08; G06T 17/05; G06T 7/30

(52) U.S. Cl. CPC G05D 1/0094; G06T 17/05; H04N 7/185; G06T 7/30; G01S 17/89; B64C 39/024; B64D 47/08; G05D 1/101; G05D 1/0088; G05D 1/0011; B64C 2201/123; B64C 2201/108

(57) ABSTRACT

An aerial scanning system creates a model of a structure using an aerial platform configured to follow a flight path of movement about the structure and an optical scanner. A control system executes processing software reading data corresponding to at least one surface of the structure and, data corresponding to movement of the aerial platform about the structure, and uses the data to construct a three dimensional model of the structure.

### CROSS-REFERENCE TO RELATED APPLICATION(S)

The present application claims the benefit of U.S. Ser. No. 62/301,268, filed Feb. 29, 2016, which is hereby incorporated by reference in its entirety.

### BACKGROUND

Throughout the United States and the world, there exists many thousands to millions of large, infrastructure-critical structures that require inspection and possibly modification to maintain functional integrity. For example, broadcast and network towers, high-voltage transmission line towers, bridges, airplanes, and wind turbines are a few structures that may require regular inspection and/or maintenance. Such maintenance may be on a regular schedule, such as yearly, to ensure early detection of damage to the structure and/or structural components. Many structures may undergo modifications as the conditions under which they operate may change and/or evolve. Cellular towers, for example, may regularly receive new or upgraded antennas. In another example, electrical towers may receive new supports for additional cabling. Regular inspection and/or upgrading of such structures may ensure long term structural integrity and/or minimize susceptibility to damage or failure.

There are issues in performing inspections and/or maintenance on such structures. First, the size of such structures may be large and cumbersome. For example, cell towers may be up to 300 feet tall. Additionally, location of the structure may be remote or involve difficult terrain, such as deep gorges for bridges. Current methods in the prior art for carrying out inspections provides for inspectors to observe the structure or video the structure for review. Alternatively, long-distance, high power swept-laser scanners may be used. Each of these methods, however, may present significant issues or limitations.

Direct inspection by human technicians may present safety risks due to extreme heights and potential weather situations. Further, direct inspection by a human may suffer from limited measurement accuracy and may prove to be costly in both time and money needed to complete the scanning and/or subsequent modification processes. Using cranes or similar equipment may present issues with inspection speed and/or scheduling. For example, such equipment may move slowly and require time to stabilize prior to taking each measurement. This in turn may slow down the inspection process. For wind turbines, only 10 cranes suitable for performing the task even exist in the United States. This may further present scheduling issues, as well as the cost of moving the crane between sites.

The use of specialized laser scanners for performing inspection may also present issues. Such equipment is known to have limited accuracy and may also require a clear view of the entire structure from a distance. This may prove difficult for structures located in dense urban areas or in densely spaced groupings.

As such, a need exists for a scanning system that may provide safe, accurate and efficient methods for measurement and/or capture of large structures. Such measurement and/or capture of large structures may provide a cost effective method for inspection and aid in maintenance and/or repair of structures.

### BRIEF DESCRIPTION OF THE DRAWINGS

Several embodiments of the present disclosure are hereby illustrated in the appended drawings. It is to be noted however, that the appended drawings only illustrate several typical embodiments and are therefore not intended to be considered limiting of the scope of the present disclosure. Further, in the appended drawings, like or identical reference numerals or letters may be used to identify common or similar elements, and not all such elements may be so numbered. The figures are not necessarily to scale, and certain features and certain views of the figures may be shown as exaggerated in scale or in schematic in the interest of clarity and conciseness. Various dimensions shown in the figures are not limited to those shown therein and are only intended to be exemplary.

FIG. 1A is a perspective view of an exemplary aerial scanning system of the present disclosure.

FIG. 1B is a schematic diagram of the exemplary aerial three-dimensional scanning system illustrated in FIG. 1A.

FIG. 2 is a perspective view of an exemplary aerial scanning system of the present disclosure having an optical scanner and a collision detection and avoidance system.

FIGS. 3A-3E illustrate diagrammatic views of exemplary optical scanner systems for use in the aerial scanning system illustrated in FIG. 2.

FIG. 3F illustrates a graph of transmission range filters used within the optical scanner system of the present disclosure.

FIG. 3G illustrates a diagrammatic view of another exemplary optical scanner system for use in the aerial scanning system illustrated in FIG. 2.

FIG. 3H illustrates a block diagram of an exemplary method of using an optical scanner system having multiple optical sensors and an optical source.

FIG. 4A is a diagrammatic view of an exemplary collision detection and avoidance system for use in the aerial scanning system illustrated in FIG. 2.

FIG. 4B is a diagrammatic view of an exemplary environment mapping system for use in the collision detection and avoidance system of FIG. 4A.

FIG. 4C is a diagrammatic view of another exemplary environment mapping system for use in the collision detection and avoidance system of FIG. 4A.

FIG. 5A is a diagrammatic view of an exemplary piloting system for use in the aerial scanning system illustrated in FIG. 2.

FIG. 5B is a diagrammatic view of an exemplary camera system for use in the piloting system illustrated in FIG. 5A.

FIG. 5C is a diagrammatic view of another exemplary camera system for use in the piloting system illustrated in FIG. 5A.

FIG. 6 is a flowchart of an exemplary method to provide one or more three-dimensional models of a structure using the aerial scanning system of the present disclosure.

### DETAILED DESCRIPTION

The present disclosure describes an aerial three-dimensional scanning system providing a safe, accurate and efficient method for measurement and capture of structures. Generally, the aerial three-dimensional scanning system may include a scanning system coupled with data processing and reconstruction software, capable of producing three-dimensional maps (i.e., scans) of structures without endangering the operator, structures, or persons in the surrounding environment.

In some embodiments, the aerial three-dimensional scanning system may provide a method for measurement and capture of large structures (e.g., 200-500 feet), although structure of any height may be measured and/or captured. Generally, the aerial three-dimensional scanning system may achieve micrometer resolution and measurement accuracy below the minimum industry requirement of 1/16^{th} of an inch. In some embodiments, the aerial three-dimensional scanning system may fly autonomously about an object during a scan avoiding obstacles (e.g., support wires, structures, surrounding vegetation).

In some embodiments, an operator may be capable of utilizing augmented reality technology to monitor the scanning process, interrupt, and/or modify the scanning process.

In some embodiments, the aerial three-dimensional scanning system may output CAD files of the structure for upgrade, modification, and/or repair. Additionally, the aerial three-dimensional scanning system may provide one or more artificial intelligence (AI) responses regarding maintenance and/or inspection. For example, the three-dimensional scanning system may provide a response of yes/no or pass/fail for maintenance and inspection purposes, respectively.

Before describing various embodiments of the present disclosure in more detail by way of exemplary descriptions, examples, and results, it is to be understood that the embodiments of the present disclosure are not limited in application to the details of systems, methods, and compositions as set forth in the following description. The embodiments of the present disclosure are capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description.

Unless otherwise defined herein, scientific and technical terms used in connection with the embodiments of the present disclosure shall have the meanings that are commonly understood by those having ordinary skill in the art. Further, unless otherwise required by context, singular terms shall include pluralities and plural terms shall include the singular.

All patents, published patent applications, and non-patent publications referenced in any portion of this application are herein expressly incorporated by reference in their entirety to the same extent as if each individual patent or publication was specifically and individually indicated to be incorporated by reference.

As utilized in accordance with the concepts of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims and/or the specification is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y, and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the term “about” is used to indicate that a value includes the inherent variation of error that exists among the study subjects. Further, in this detailed description, each numerical value (e.g., temperature or time) should be read once as modified by the term “about” (unless already expressly so modified), and then read again as not so modified unless otherwise indicated in context. Also, any range listed or described herein is intended to include, implicitly or explicitly, any number within the range, particularly all integers, including the end points, and is to be considered as having been so stated. For example, “a range from 1 to 10” is to be read as indicating each possible number, particularly integers, along the continuum between about 1 and about 10. Thus, even if specific data points within the range, or even no data points within the range, are explicitly identified or specifically referred to, it is to be understood that any data points within the range are to be considered to have been specified, and that the inventors possessed knowledge of the entire range and the points within the range. Further, an embodiment having a feature characterized by the range does not have to be achieved for every value in the range, but can be achieved for just a subset of the range. For example, where a range covers units 1-10, the feature specified by the range could be achieved for only units 4-6 in a particular embodiment.

As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

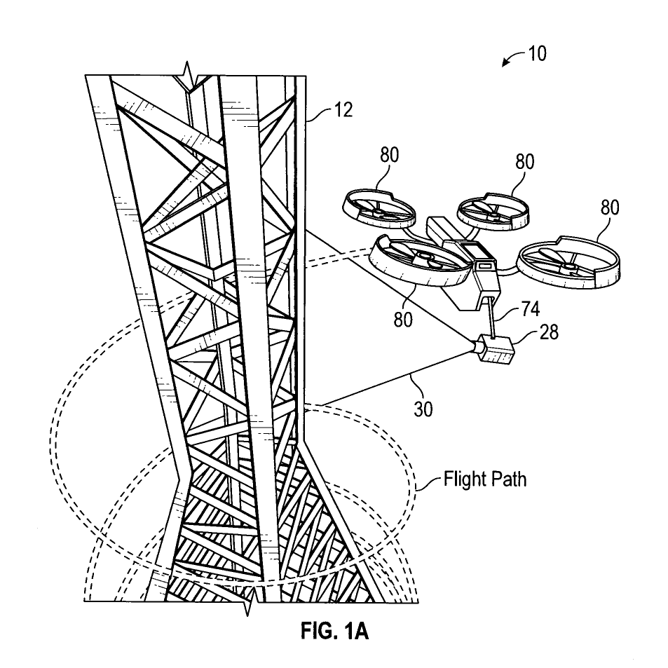

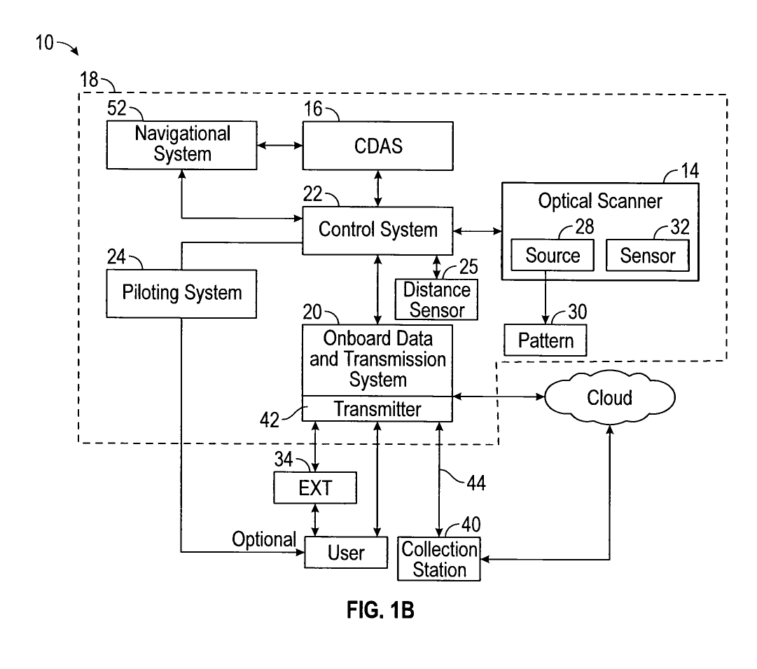

Referring to the Figures, and in particular to FIGS. 1A and 1B, illustrated therein is an aerial scanning system 10 for constructing one or more three-dimensional scans of one or more structures 12 in accordance with the present disclosure. Generally, the aerial scanning system 10 is configured to provide three-dimensional scans (e.g., maps) of structures without endangering the operator, the structure 12, or persons in surrounding environments. For example, the structure 12 may be a utility tower having antennas, wire and other obstacles. The aerial scanning system 10 may follow a flight path about the structure 12 (e.g., rotate about the tower) at a relatively close distance avoiding obstacles such as the tower, antenna, wire, and/or the like. Additionally, the aerial scanning system 10 may be configured to output three dimensional or two dimensional files (e.g., CAD files) of the structure 12 for upgrade, modification and/or repair purposes.

In some embodiments, the aerial scanning system 10 may include one or more artificial intelligence (AI) responses (e.g., yes/no, pass/fail) for maintenance and/or inspection recommendation and/or action items. For example, the aerial scanning system 10 may scan the structure 12 (e.g., utility tower) with high accuracy. An AI analysis and inspection software may process a three-dimensional generated file (e.g., CAD file) to determine if there is a failure (e.g., bar, rode, and/or piece of the structure 12 having a bend and/or weak portion, loose screw, and/or the like). The AI analysis and inspection software may provide one or more communications (e.g., report) to a user indicating location of failure and/or one or more recommendation and/or action items (e.g., replace bar, tighten screw) related to the failure. The AI analysis and inspection software may also provide a “Pass Inspection” response if no failure is determined.

In some embodiments, the aerial scanning system 10 may comprise an optical scanner 14, a collision detection and avoidance system 16, an aerial platform 18, onboard data processing and transmission system 20, a control system 22, and a piloting system 24. In some embodiments, the aerial scanning system 10 may further include a distance sensor 25 configured to measure a distance between the aerial platform 18 and the structure 12. The distance sensor 25 may measure the distance between the aerial platform 18 and the structure 12 when the aerial scanning system 10 is in use and/or for each scan obtained, for example. Generally, each element of the aerial scanning system 10 may be used in conjunction to construct one or more three-dimensional scans of the structure 12. For example, using the piloting system 24, a user may pilot the aerial platform 18 via virtual reality, augmented reality, smartphone (e.g., iPhone), tablet, joystick, remote control system, and/or the like. In some embodiments, the aerial scanning system 10 may be piloted autonomously (i.e., user direction may be optional). One or more cameras (e.g., stereoscopic camera, standard camera, 360 degree camera, combinations thereof, or the like) on the aerial platform 18 may present one or more views of the environment to the user. For example, the user may be provided one or more views of a natural environment for positioning and/or moving the aerial platform 18 around the structure 12. The virtual or augmented reality may allow for the user to observe the structure 12 and/or the environment from the point of view of the aerial platform 18, as if the user is on the aerial platform 18. Additionally, virtual or augmented reality may provide the user additional information about flight and/or operating status of the aerial platform 18. In some embodiments, the user may utilize a radio-frequency control module configured to transmit commands to the aerial platform 18 during flight of the aerial platform 18. The nature of the commands may depend on flying and/or propulsion mechanism in use by the aerial platform 18, including, but not limited to, multiple rotors (e.g., quad or octo-rotor), jet propulsion, or the like.

Once the aerial platform 18 is in flight, the optical scanner 14 may be used to gather data regarding the structure 12. The optical scanner 14 may include an optical source 28 capable of projecting an optical pattern 30 on the structure. An optical sensor 32 of the optical scanner 14 may record data of the illumination (i.e., projection of the optical pattern 30) on the structure 12. The mounting of the optical source 28 and the optical sensor 32 on the aerial platform 18 may provide the rigidity to ensure that the optical source 28 and the optical sensor 32 remain in the same geometrical relationship (i.e., static geometrical relationship) with each other without significant movement during and/or between recording events. Additionally, such mounting may be lightweight to avoid consuming payload capacity of the aerial platform 18.

The data obtained from the optical sensor 32 may be combined with knowledge of distance between the optical source 28 and the optical sensor 32, angular orientation of the optical source 28 and the optical sensor 32, and content of the optical pattern 30 to estimate the three-dimensional structure of the structure 12 using active triangulation algorithms. The distance between the optical source 28 and the optical sensor 32, angular orientation of the optical source 28 and the optical sensor 32 can be fixed or dynamic. But, when the distance and the angular orientation are dynamic, then such may be known prior to utilization in the active triangulation algorithms. In some embodiments, the optical source 28 may illuminate the structure 12 with a single optical pattern 30 for each reading. To improve accuracy of the three-dimensional model, in some embodiments, the optical scanner 14 may illuminate the structure 12 with a series of optical patterns 30. Each pattern in the series may provide additional data about the structure 12 to alter the three-dimensional model. During the illumination series, the user may attempt to maintain the aerial platform at a stationary position (i.e., reducing movement between two patterns in series).

In some embodiments, an optional external optical system 34 may provide additional low resolution scans of the environment surrounding the aerial platform 18 from a ground position. An exemplary external optical system 34 may be the Intel RealSense technology, manufactured by Intel having a principal place of business in Santa Clara, Calif. Such scans may provide data on the environment surrounding the aerial platform 18 including, but not limited to, objects interfering with the flight path of the aerial platform 18 that an on-board camera may not be capable of viewing, the structure 12, and/or the like. The user and/or the control system 22 may use such data to avoid collisions with the structure 12 and/or interfering objects that may damage, incapacitate and/or destroy the aerial platform 18.

The control system 22 may generally coordinate the operation of the optical scanner 14, the collision detection and avoidance system 16, the onboard data processing and transmission system 20 and the distance sensor 25. For example, for the optical scanner 14, the control system 22 may determine the number of optical patterns 30 displayed per second, illumination time for each optical pattern 30, and/or the time at which the optical scanner 14 may sample and/or store the output for further processing and/or transmission. The control system 22 may obtain input from the collision detection and avoidance system 16 and either alert the user when the aerial platform 18 may be at a pre-determined distance to the structure 12 or interfering object, thus allowing the user to decide appropriate action. In some embodiments, the control system 22 may signal the aerial platform 18 to take rapid evasive action independent of the user.

In some embodiments, the onboard data processing and transmission system 20 may perform initial electronic processing in preparation for transmission to a collection station 40. Such processing may include, but is not limited to, data compression, preliminary registration (e.g., compensation for movement of the aerial platform 18 between captures), encapsulation of data in a format used by a transmission link, and/or the like.

In some embodiments, a transmitter 42 (e.g., RF transmitter) of the onboard data processing and transmission system 20 may transmit the processed data to the collection station 40. For example, the transmitter 42 may transmit the processed data to the collection station via a network 44 and/or cloud. Such network 44 may be implemented as the World Wide Web (or Internet), a local area network (LAN), a wide area network (WAN), a metropolitan network, a wireless network, a cellular network, a Global System for Mobile Communications (GSM) network, a code division multiple access (CDMS) network, a 3G network, a 4G network, a 5G network, a satellite network, a radio network, an optical network, a cable network, a public switched telephone network, an Ethernet network, combinations thereof, and/or the like. It is conceivable that in the near future, embodiments of the present disclosure may use more advanced networking topologies.

Location of the collection station 40 may include, but is not limited to, a vehicle, building, or other stationary object, or a second aerial vehicle (e.g., airplane). Within the collection station 40, or within a second location in communication with the collection station 40, a receiver may collect and/or retrieve the processed data sent by the transmitter 42. The collection station 40 may include one or more processors having processing software configured to convert the processed data into three-dimensional models using registration, generalization and fusion processing cycles for constructing three-dimensional models. The one or more processors may format the three-dimensional model (e.g., SolidWorks file), and/or deliver the three-dimensional model to an end user.

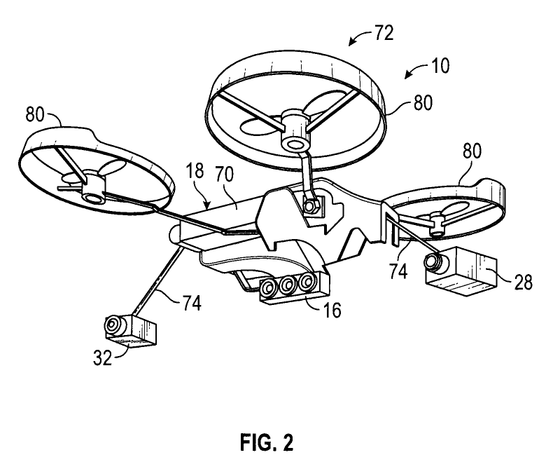

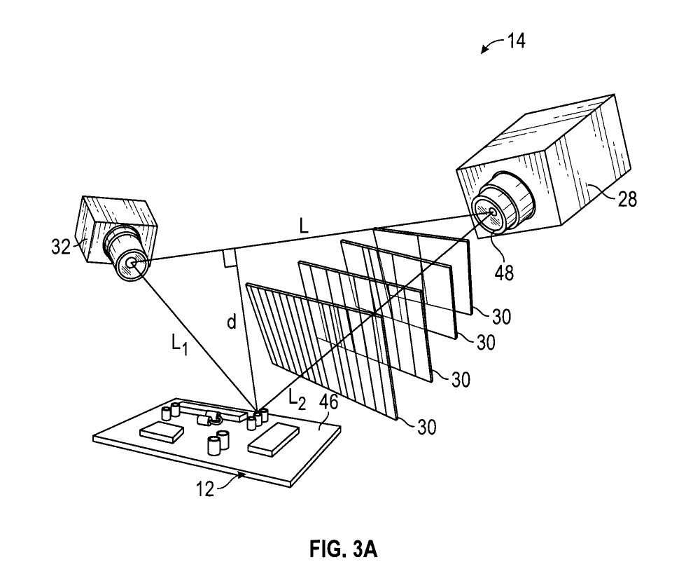

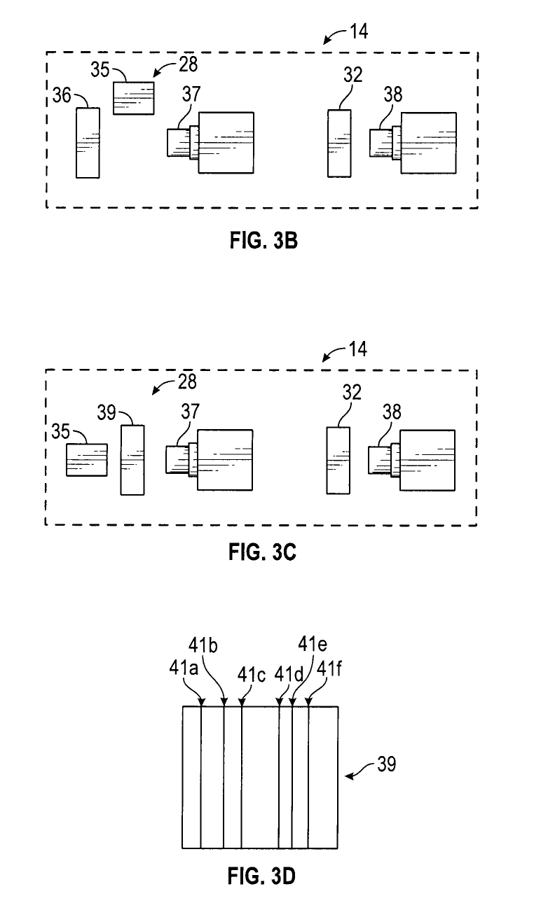

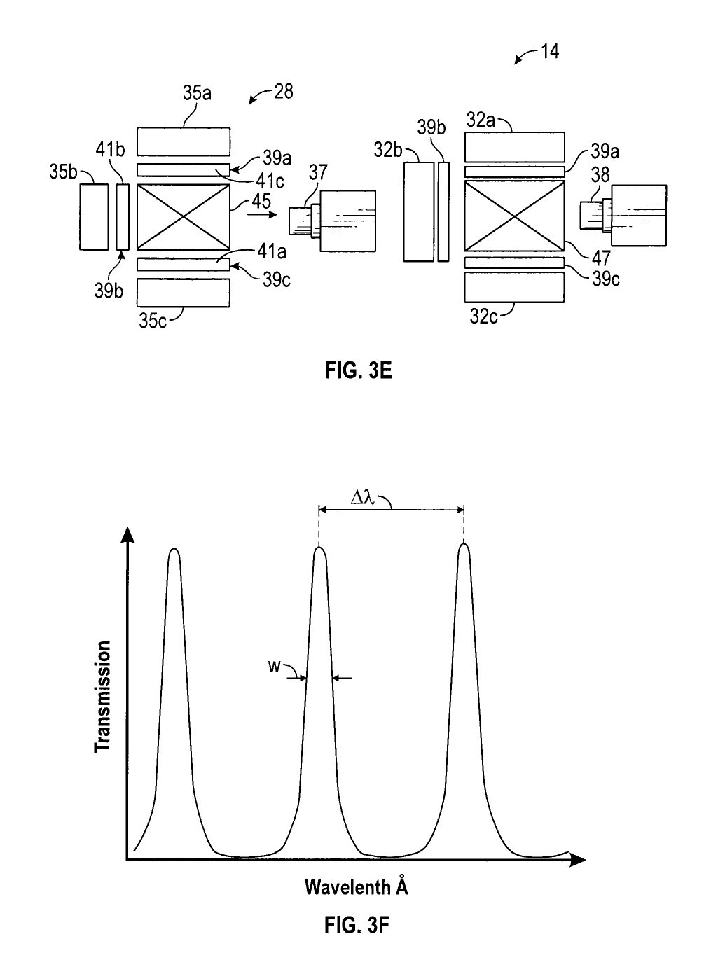

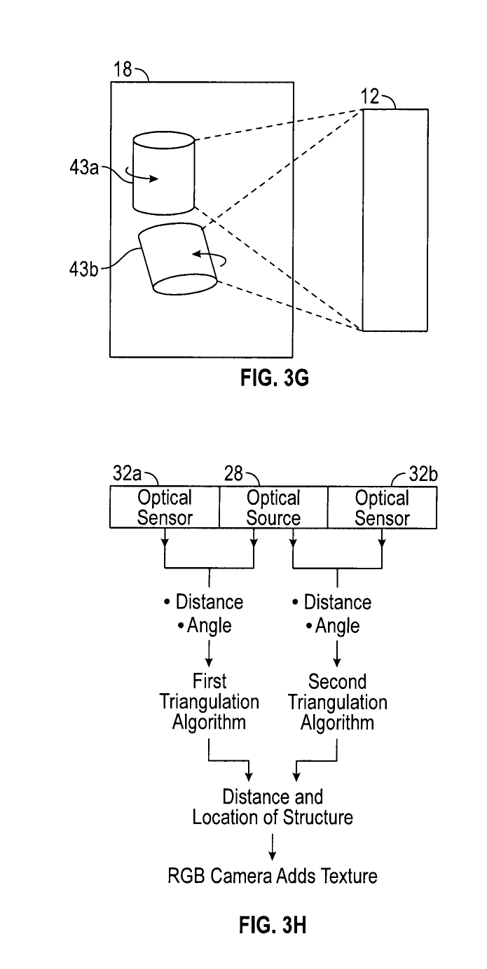

Referring to FIGS. 2 and 3A, the optical scanner 14 may include one or more optical sources 28 capable of projecting one or more optical patterns 30 onto the structure 12 and one or more optical sensors 32 capable of measuring spatial variation in intensity and/or color of the optical pattern 30 on the structure 12. Generally, the one or more optical sources 28 and the one or more optical sensors 32 may be separated by a known and fixed lateral distance l as shown in FIG. 2. Additionally, the one or more optical sources 28 and the one or more optical sensors 32 may be oriented at fixed angles to a line connecting the one or more optical sources 28 and the one or more optical sensors 32.

The optical source 28 may be any light source capable of generating one or more optical patterns 30 (e.g., a high resolution 1920×1080 optical pattern). For example, the optical source 28 may include, but is not limited to, digital light processing (DLP), liquid crystal display (LCD), liquid crystal on silicone (LCoS), mask screens, arrays of light emitters (e.g., light-emitting diodes (LEDs)), and/or the like. The optical source 28 may be limited to single color systems (e.g., red, blue, green, infrared light, UV light, laser of these wavelengths) or multicolor systems (e.g., RGB, RG, GB, RB, combinations of infrared wavelengths, visible and infrared wavelengths, UV and possible combinations, or laser of these wavelengths).

The optical pattern 30 projected by the one or more optical sources 28 may be any color of light. For example, the optical pattern 30 may include a single color of light, different colors of light, gray scales of light, different color and different gray scales, and/or the like. Generally, the one or more optical patterns 30 may be selected such that data volume is produced that is sufficient for accurate reconstruction. Such optical patterns 30 may include, but are not limited to, a set of high resolution optical patterns, binary patterns, gray patterns, phase shift patterns, hybrid gray and phase shift patterns, rainbow patterns, continuously varying color patterns, color coded stripes, segmented stripes, gray scale coded stripes, De Bruijin Sequence, Pseudo Random Binary dots, mini-patterns as codewords, color coded grids, two dimensional coded dot array, and/or any combination thereof. Exemplary patterns and associated measurement techniques may be found in the article by Jason Geng, Structured-light 3D Surface Imaging: a tutorial, Advances in Optics and Photonics 3, 128-160 (2011), a copy of which is submitted herewith and is hereby incorporated by reference in its entirety.

During the scanning process, the optical source 28 may illuminate the structure 12 with one or more different images or frames (i.e., multi shots such as binary code, gray code, phase shift code, hybrid of gray code and phase shift code, other hybrids, and/or the like), or single image or frame (i.e., single shot such as color coded stripes, segmented stripes, gray scale coded stripes, De Bruijin sequence, pseudo random binary dots, mini-patterns as codewords, color coded grid, two dimensional color coded dot array, hybrids, and/or the like).

Generally, illumination and/or the optical pattern(s) 30 may be executed according to a pre-determined protocol, such as the techniques defined in the article by Jason Geng cited herein and incorporated by reference in its entirety. Key parameters for selection of the appropriate protocol may include frame speed (number of images or frames the pattern generator may produce in full per unit time), resolution of the pattern generator (e.g., density and size of mirrors, liquid crystal cells, or light emitters in the array). For example, in some embodiments, the DMD may provide diversity of optical patterns 30 per unit of time and a large number of illumination points as compared to other methods for producing optical patterns 30.

The optical sensor 32 may obtain data for each frame for multi shots and a single frame for a single shot. The determination of multi shot or single shot may be based on avoidance in errors for reconstruction, decrease software complexity and/or increased accuracy. Errors, for example, may arise when a portion of an object obstructs and/or shadows the structure 12. In this example, optical patterns 30 may have illuminated areas and non-illuminated areas with each area being able to reveal details of the structure 12.

In some embodiments, the optical source 28 may sequentially illuminate the structure 12 with optical patterns 30 of different colors. Such sequential illumination may reduce and/or eliminate loss of accuracy that may occur when the structure 12 and the optical source 28 have similar colors.

Referring to FIG. 3B, in some embodiments, the optical source 28 may be a DLP source having an illumination module 35, a digital micromirror device (DMD) 36, and a projection lens 37. The illumination module 35 may deliver optical power at one or more multiple wavelengths to the DMD 36. The DMD 36 may include one or more arrays of electro-mechanical mirrors. The pattern of activated and deactivated mirrors may modulate the incoming illumination providing a pattern of illumination at the output plane. The projection lens 37 may produce a clear image of the optical pattern 30 or code at a designed distance. The projection lens 37 may include, but is not limited to, one or more liquid lens, dynamic lens, variable lens, mechanical lens, tunable lens, electroactive polymer lens, and/or the like. In some embodiments, the projection lens 37 may be a tunable lens configured to later focus based on one or more communications from the control system 22. For example, the control system 22 may alter the focus of the tunable lens based on a measured distance between the aerial platform 18 and the structure 12. Exemplary tunable lens may be manufactured by Optotune having a principal place of business in Switzerland or Varioptic having a principal place of business in Lyons, France. In using a tunable lens, for example, the distance between the aerial platform 18 and the structure 12 may be different each time the optical scanner 14 operates. To that end, tuning of the optical scanner 14 may be automatic (i.e., distance may be varied and not fixed each time the optical scanner 14 operates). It should be noted that the LDC, LCoS, mark screen and light-emitter array may also produce patterns of illumination, though by means one skilled in the art will appreciate.

Additionally, in some embodiments, the optical sensor 32 may be used in conjunction with one or more camera lens 38 as shown in FIG. 3B. Similar to the projection lens 37, the camera lens 38 may include, but is not limited to, one or more liquid lens, dynamic lens, variable lens, mechanical lens, tunable lens, electroactive polymer lens, and/or the like. Further, the control system 22 may be configured to alter the focus of the camera lens 38 automatically (i.e., without human intervention). For example, the control system 22 may be configured to alter the focus of the camera lens 38 using the measured distance between the aerial platform 18 and the structure 12 obtained via the distance sensor 25 (shown in FIG. 1B). In some embodiments, the projection lens 37 may be a tunable lens configured to later focus based on one or more communications from the control system 22. After the focal lengths of the projection lens 37 and/or the camera lens 38 are adjusted (e.g., adjusted automatically via the control system 22), the focal lengths of the projection lens 27 and the camera lens 38 will be known. In some embodiments, the focal length f of the projection lens may be equal to the focal length f of the camera lens 38.

Referring to FIGS. 1B and 3B, in some embodiments, the aerial platform 18 may further include one or more distance sensors 25 (e.g., ultrasonic sensor, optical time of flight sensors (e.g., laser), triangulation sensor, and/or the like) configured to measure the distance between the aerial platform 18 and the structure 12 prior to scanning. The measured distance between the aerial platform 18 and the structure 12 may additionally be used to tune the projection lens 37 and/or the camera lens 38 to project and/or capture clear and/or substantially clear patterns and/or images. The control system 22 may automatically (i.e., without human intervention) alter the projection lens 37 and/or the camera lens 38 using measured distance obtained from the distance sensor(s) 25.

In some embodiments, the projection lens 37 and/or the camera lens 38 may include shutters (e.g., (f/16), (f/8), (f/2-8)). When the aperture of the shutter is in an open position (f/2-8) the projection lens 37 and/or the camera lens 38 may focus on a plane at a specific location. The aerial platform 18, as such, may fly and/or hover at a specific distance based on the focal length f of the lens (projection lens 37 and/or camera lens 38) to scan that portion of the structure 12 and receive a clear scan. When the aperture of the shutter is small (e.g., (f/16), (f/8)), the projection lens 37 and/or the camera lens 38 may focus over a specific depth (e.g., +/−10 cm), thus allow for the optical scanner 14 to operate and scan at a variable distance. It should be noted that reducing the aperture may affect brightness of the projected optical patterns 30 and captured images.

FIGS. 3C and 3D illustrate another exemplary embodiment of the optical scanner 14 wherein the optical source 28 includes one or more masks 39. In some embodiments, the mask 39 may include two or more layers positioned adjacent to one another. For example, a first layer may include a first pattern. A second layer may include one or more filters 41 for each individual pixel (e.g., magenta 41a, cyan 41b, yellow 41c, green 41d, blue 41e, red 41f filters) aligned adjacent (e.g., directly on top of) the patterns to produce a colored pattern without the need for DLP or DMD optical source. Generally, in this example, the optical sensor 32 may include a color sensor (e.g., IR, UV, combination thereof, and/or the like).

FIG. 3E illustrates another exemplary embodiment of the optical scanner 14 wherein the optical source 28 includes a plurality of illumination sources 35a, 35b, and 35d and a plurality of masks 39a, 39b and 39d. Filters 41 within the masks 39a, 39b, and 39d may be any colors (e.g., magenta 41a, cyan 41, yellow 41c, green 41d, blue 41e, red 41f, IR, UV, or combinations thereof). In some embodiments, each filter 41 may be configured to pass one or more specific colors (e.g., pass two or more colors to increase differentiation and/or accuracy). A combiner 45 may combine all patterns from each of the filters 41 and deliver to the projection lens 37. Further, the optical scanner 14 may include multiple optical sensors 32a, 32b and 32c, for example. Each optical sensor 32a, 32b and 32c may include one or more masks 39a, 39b and 39c, for example. The masks 39a, 39b and 39c allow transmission of specific wavelengths and rejection of specific wavelengths. A combiner 47 may distribute the received images from the camera lens 38 to the three sides. To that end, the optical source 28 may project three single shots and the optical sensor 32 may receive three single shots at any instance and may increase accuracy.

Referring to FIG. 3F, in some embodiments, filters 41 used at the optical source 28 may be designed in respect to filters 41 used at the optical sensor 32. For example, filters 41b of the optical source 28 may allow for projection of three colors R, G and B based on pixel distribution, and filters 41b of the optical sensor 32 may allow for images that include only R, G and B colors to pass through while reflecting the rest of the wavelengths. In some embodiments, the filters 41 may be Fabry Perot filters. For example, filter 41b may be configured to transmit images of R, G, and B colors while filter 41c may transmit images of CYM. In some embodiments, one or more bandpass filters may be used as filters 41 to provide transmission of different ranges and/or spectrums of wavelengths at each side of the combiner 45 (e.g., prism).

The optical sensor 32 may provide spatial resolution in measuring the object under illumination by the optical source 28. The design of the optical sensor 32 may include, but is not limited to, a high-density detector array (e.g., high density charge-couple device (CCD) array), CMOS, array of photo-detection elements coupled to a high quality imaging lens, or the like. Exemplary resolutions may include, but are not limited to for 8K resolution of 7,680×4,320, for 4K (UHD) resolution of 3,840×2,160, for WUXGA resolution of 1,920×1,200, for 1080p resolution of 1,920×1,080, for XGA resolution of 1,024×768. The optical source 28 may operate at a wavelength detectable by the optical sensor 32. In some embodiments, the optical source 28 may deliver optical power to the structure 12 such that the optical sensor 32 and the subsequent processing electronics may accurately record the projected optical pattern 30 even in the presence of high brightness ambient lighting conditions (e.g., bright sunlight). Alternatively, the scanning process may be scheduled for a time at which high brightness ambient lighting conditions are minimized. For example, in using the autonomous piloting system 24 described in further detail herein, the scanning process may be scheduled during night-time or dark lighting conditions.

In some embodiments, one or more additional cameras may be included within the optical scanner 14 to provide color and/or texture for the three-dimensional model. For example, one or more RGB cameras may be included within the optical scanner 14. Subsequent to scanning of the structure 12, the one or more additional cameras may capture one or more additional images. Such images may be used to add color and/or texture to the data obtained by the optical sensor 32. During processing, such color and texture data may be applied to the three-dimensional model.

Referring to FIG. 3F, n some embodiments, the optical scanner 14 may include a Light Detection and Ranging (LiDAR) system 43. Generally, the LiDAR system 43 may measure distance to the structure 12 based on known speed of light and measurement of the time-of-flight of a light signal between the light or laser source and camera at one end (e.g., positioned on the aerial platform 18) and the structure 12 for each point of the image. Each LiDAR system 43 may include optical transmitters (e.g., 64 optical transmitters) and optical receivers (e.g., 64 optical receivers) aligned on a single rotating column, for example. The time-of-flight camera is a class of scanner wherein an entire scene may be captured with each laser or light pulse, as opposed to a point-by-point capture used in scanning LiDAR systems 43. An exemplary LiDAR system 43 for use in the optical scanner 14 may include the Velodyne LiDAR, manufactured by Velodyne having a principal place of business in Morgan Hill, Calif. In this example, the horizontal resolution may be higher than the vertical resolution. For example, the Velodyne has a horizontal resolution of 0.08 degrees and a vertical resolution of 0.4 degrees. In some embodiments, a single LiDAR system 43 may be included in the optical scanner 14 with horizontal resolution scanning horizontally.

In some embodiments, multiple LiDAR systems 43 may be included within the optical scanner 14. For example, as illustrated in FIG. 3G, two LiDAR systems 43a and 43b may be included within the optical scanner 14 with an angle between each system (e.g., 90 degrees) to capture horizontal resolution from each LIDAR system and scan both axes with high resolution scanning data. In this example, the resolution captured vertically and horizontally may be at 0.08 when using two Velodyne systems.

In some embodiments, the optical scanner 14 may include any combination of optical sources 28, optical sensors 32 and/or LIDAR systems 43. For example, the optical scanner 14 may include a LIDAR system with DLP structured light scanner, RGB camera with structured light system, RGB with structured light system and LIDAR system, RGB with structured light system and two LIDAR systems mounted perpendicular to each other, and/or the like.

The optical scanner 14 may operate on the principle of active triangulation. In some embodiments, computations may be determined by the control system 22, the onboard processing system 20 and/or the collection station 40. In some embodiments, computations may be determined by the control system 22 and/or the onboard processing system 20 and stored in one or more memory. The memory may then be transported and/or transmitted to the collection station 40 (e.g., via network, upon landing of the aerial platform 18 and/or the like.)

FIG. 3A depicts the relative positioning and orientation of the optical source 28 and the optical sensor 32. Known parameters may include the distance l between the optical source 28 and the optical sensor 32 and the angles of the optical source 28 and the optical sensor 32 with respect to a line connecting them. The optical sensor 32 may detect a point projected onto the structure 12. The position of the point on a surface 46 of the structure 12 detected by the optical sensor 32 may provide for determination of the line l₁ between the spot and a surface 48 of the optical sensor 32 (e.g., center of the surface 48 of the optical sensor 32). The line l₁ may be determined using knowledge of the location and angle of the optical sensor 32. A triangulation algorithm may then determine the location of point on the detecting surface 46, by determining the intersection of lines l₁ and l₂.

An exemplary triangulation algorithm is shown below. Generally, the point (x, y, z) on the structure 12 and the location of its image on the optical sensor (x*, y*) relate to each other through the perspective transformations:

(T₁₁−T₁₄x*)x+(T₂₁−T₂₄x*)y+(T₃₁−T₃₄x*)z+(T₄₁−x*)=0, (EQ. 1)

(T₁₂−T₁₄y*)x+(T₂₂−T₂₄y*)y+(T₃₂−T₃₄y*)z+(T₄₂−y*)=0, (EQ. 2)

wherein T defines the scene to image transformation matrix determined for a given position and angle of the optical sensor 32. Similarly, the optical source 28 located at (u, w) may have a perspective transformation:

(L₁₁−L₁₄u)x+(L₂₁−L₂₄u)y+(L₃₁−L₃₄u)z+(L₄₁−u)=0, (EQ. 3)

(L₁₂−L₁₄w)x+(L₂₂−L₂₄w)y+(L₃₂−L₃₄w)z+(L₄₂−w)=0, (EQ. 4)

wherein L defines the scene to source transformation matrix for a given position and angle of the optical source 28. Both T and L depend on the system geometry in FIG. 2. If the optical source 28 projects the structured optical pattern 30 onto the detection surface 46, solving the four equations may produce an estimate of each coordinate triplet (x, y, z) within the optical pattern 30, as the equations may be inconsistent due to error sources. The computation may arrive at a best estimate of coordinates by a least squares approach.

In some embodiments, resolution and/or accuracy may be achieved by selection of particular components and/or use of one or more reconstruction algorithms. Such parameters may include, but are not limited to, the separation distance l, the working distance d, maximum area of the structure 12 illuminated by the optical source 28, sensor resolution, DMD resolution, LCD resolution, emitter array or similar device used to generate the optical patterns 30, range of magnifications produced by the projection optics of the optical source 28, and/or the like. For example, the DLP4710 DMD, manufactured by Texas Instruments having a principal place of business in Dallas, Tex., has an orthogonal 1920×1080 array of mirrors on a 5.4 μm pitch with a 0.47 inch diagonal. The selection of the particular DMD is not limited to this example, however, the selection of DMD may consider the DMD size and method of illumination (side illumination vs. corner illumination), as small DMD size and use of side illumination may reduce size and weight of the optical components, thereby reducing the size and weight of the optical source 28. Common projection optics may produce a 1.3×0.8 m illuminated area at about 1.8 m, which may serve as a minimum working distance d to ensure safe flight of the aerial platform 18 around the structure 12 undergoing scanning. In some embodiments, the distance l may be minimized to achieve a target resolution such that the optical scanner 14 may not impact flying dynamics or payload capacity of the aerial platform 18. A target accuracy for expected commercial application may be less than or equal to 1/16^{th} inch. Generally, a longer working distance may include a longer distance l to obtain the same accuracy, and the aerial scanning system 10 may balance working distance d and distance l for a given application.

In some embodiments, multiple optical sensors 32 may be used with the optical source 28 in the optical scanner 14. For example, in FIG. 3H, the distance and angle between the first optical sensor 32a and the optical scanner 14 may be determined and/or known. The distance and angle between the second optical sensor 32b and the optical scanner 14 may be determined and/or known. A first triangulation algorithm may be performed for the first optical sensor 32a and the optical source 28 and a second triangulation algorithm may be performed for the second optical sensor 32b and the optical source 28. Using the results of the first triangulation algorithm and the second triangulation algorithm, the location of the point on the structure 12 may be determined and accuracy of such determination may be increased as compared to use of a single triangulation algorithm. Additionally, one or more additional cameras (e.g., RGB camera) may be configured to provide texture and/or additional data as described in further detail herein.

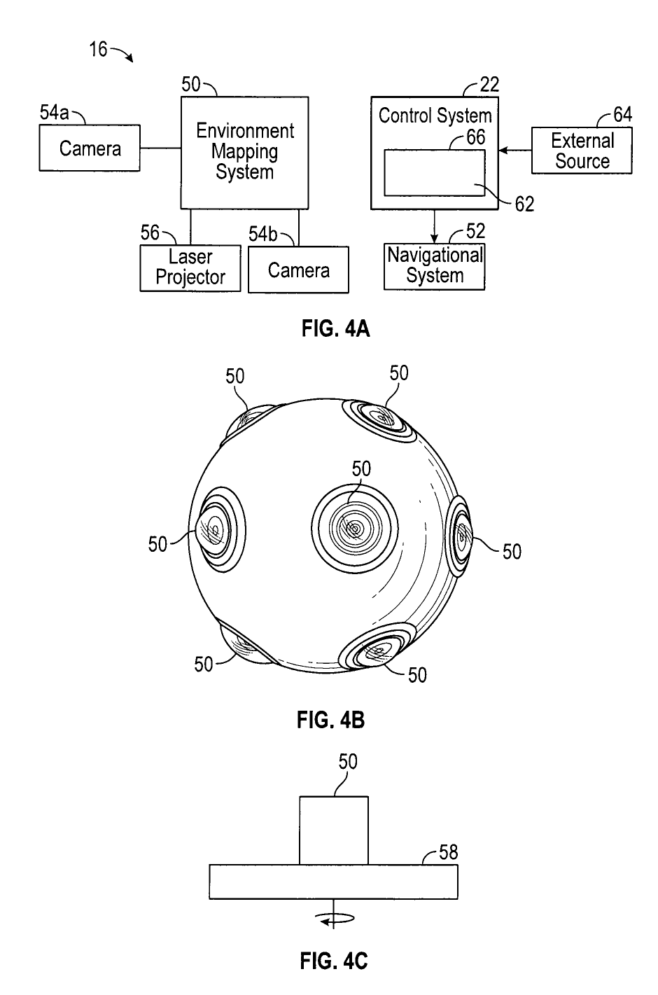

Referring to FIGS. 4A-4C, the collision detection and avoidance system (CDAS) 16 may include an environment mapping system 50 and one or more navigational systems 52.

In some embodiments, the environment mapping system 50 may provide insufficient resolution to perform high-accuracy measurements of the structure 12; however, the environment mapping system 50 may provide sufficient three-dimensional renderings of the environment about the structure 12 for identification of obstacles in the flight path, proximity of the aerial platform 18 to the structure 12, and/or the like. The environment mapping system 50 may additionally create real-time digital three-dimensional representations of the environment.

In some embodiments, the environment mapping system 50 may include two or more cameras 54 (e.g., RGB camera, IR camera) and/or one or more illumination sources 56 (e.g., laser projector). In some embodiments, a single wavelength specific pattern may be used in lieu of or in addition to the one or more illumination sources 56. An exemplary environment mapping system 50 is RealSense system, manufactured by Intel having a principal place of business in Santa Clara, Calif.

In some embodiments, the environment mapping system 50 may include one or more RGB cameras 54a, one or more IR cameras 54b, and one or more laser projectors as the illumination source as shown in FIG. 4A. The IR camera(s) 54b of the environment mapping system 50 may provide one or more stereoscopic recordings. Such stereoscopic recording may be used to determine depth data of the environment. By combining such stereoscopic readings with the data obtained by use of the one or more illumination sources 56, the environment mapping system 50 may be able to provide a three-dimensional capture of the physical world. For example, the environment mapping system 50 may be configured to build a real-time digital representation of the three-dimensional scene and also provide data on distance to objects within the field of view. Even further, by using multiple environment mapping systems 50, the CDAS system 16 may be capable of detection of objects over a larger field of view (e.g., 120 degrees) depending on placement and/or angular orientation of each environment mapping system 50.

Generally, the environment mapping system 50 may provide full three-dimensional imaging and information regarding the environment in which the aerial platform 18 may operate. In some embodiments, multiple environment mapping systems 50 may be positioned in a spherical geometry such that each environment mapping system 50 may be oriented with its central axis directing outward from an effective or real surface of the sphere as illustrated in FIG. 4B. Referring to FIG. 4C, in some embodiments, one environment mapping system 50 may be positioned on a platform 58. The platform 58 may rotate independently of the aerial platform 18 and the optical scanner 14 such that the CDAS system 16 may be configured to scan the surrounding environment in a manner similar to a swept radar antenna (e.g., rotational movement for 360 degree horizontal mapping).

The control system 22 may receive data from the environment mapping system 50 and identify one or more objects of interest (e.g., objects of concern that may impede flight of the aerial platform 18). The control system 22 may use any computational algorithm existing for identification of objects of interest in three-dimensional mappings of physical environments. Generally, the control system 22 may include one or more processors 60 configured to automatically execute this methodology to identify and/or obtain information about objects of interest for a variety of purposes. In some embodiments, control system 22 may be configured to generate one or more reports for one or more objects of interest without manual or human intervention. For example, the methodology may be automatically executed by the one or more processors 60 to generate GPS coordinates, Cartesian map coordinates, simple distance and direction data, and/or the like. Such data may be used within the navigational system 52 to operate the aerial platform 18 and/or provided to a user for remote piloting of the aerial platform 18, for example. The control system 22 may format, configure and/or transmit the data to match ports (e.g., input/output ports) and protocols of receiving systems, including the user.

The control system 22 may include the one or more processors 60. In some embodiments, the processor 60 may be partially or completely network-based or cloud-based. The processor 60 may or may not be located in a single physical location. Additionally, multiple processors 60 may or may not be necessarily be located in a single physical location.

The processor(s) 60 may include, but are not limited to, implementation as a variety of different types of systems, such as a digital signal processor (DSP), a central processing unit (CPU), a field programmable gate array (FPGA), a microprocessor, a multi-core processor, a quantum processor, application-specific integrated circuit (ASIC), a graphics processing unit (GPU), a visual processing unit (VPU), combinations thereof, and/or the like.

The processor 60 may be capable of reading and/or executing executable code stored in one or more non-transitory processor readable medium 62 and/or of creating, manipulating, altering, and/or storing computer data structures into the one or more non-transitory processor readable medium 62. The non-transitory processor readable medium 62 may be implemented as any type of memory, such as random access memory (RAM), a CD-ROM, a hard drive, a solid state drive, a flash drive, a memory card, a DVD-ROM, a floppy disk, an optical drive, and combinations thereof, for example. The non-transitory readable medium 62 may be located in the same physical location as the processor 60, or located remotely from the processor 60 and may communicate via a network. The physical location of the non-transitory processor readable medium 62 may be varied, and may be implemented as a “cloud memory”, i.e., one or more non-transitory processor readable medium 62 may be partially, or completely based on or accessed via a network.

In some embodiments, the control system 22 may configured to receive additional data from one or more external sources 64. In some embodiments, the external source 64 may be user inputted data. In some embodiments, the external source 64 may be data associated with a third party system (e.g., weather, GPS satellite). The information may be provided via a network or input device, including, but not limited to, a keyboard, touchscreen, mouse, trackball, microphone, fingerprint reader, infrared port, slide-out keyboard, flip-out keyboard, call phone, PDA, video game controller, remote control, fax machine, network interface, speech recognition, gesture recognition, eye tracking, brain-computer interface, combinations thereof, and/or the like.

In some embodiments, prior to movement of the aerial platform 18, a user may provide the control system 22 with some or all parameters to aid the CDAS system 16 in navigation. Parameters may include, but are not limited to, shape of structure 12, type of structure 12, suggested flight path, estimated height of structure 12, ground diameter of structure 12. The CDAS system 16 may include AI software configured to navigate the aerial platform 18 based on parameters, received data from environment mapping, extracted data from scanning data processed onboard or provided via network from a user, and/or the like.

Referring to FIG. 1-2, the aerial platform 18 may be configured to support and move the optical scanner 14, CDAS 16, onboard processing and transmission system 20, control system 22, and piloting system 24 within the air. Generally, the aerial platform 18 may be configured to move at a predetermined low speed (e.g., 1 km/h). Additionally, the aerial platform 18 may be configured to hover (i.e., remain stationary) within the air. For example, the aerial platform 18 may be configured to move at a low speed or hover as the optical scanner 14 obtains one or more scans of one or more areas of the structure 12. The aerial platform 18 may also include load capacity permitting unimpeded aerial navigation while transporting the optical scanner 14 and CDAS 16. Further, the aerial platform 18 may be configured to carry fuel to sustain long periods of flight (e.g., 2 hours) prior to refuelling to minimize time to complete a scanning process for the structure 12.

Generally, the aerial platform 18 may include one or more mechanical platforms 70, one or more propulsion systems 72, and one or more mounting systems 74. The navigational system 52 may aid in providing direction to the one or more propulsion systems 72.

In some embodiments, the propulsion system 72 may include four or more rotors 80 (e.g., quadcopter, octocopter), such as a drone. In some embodiments, the four or more rotors 80 may be electric-powered rotors. In some embodiments, relative rotational velocity of the four or more rotors 80 may be configured to control direction and/or speed of flight of the aerial platform 18. By controlling the relative rotational velocity of the four or more rotors 80, the aerial platform 18 may obtain slow and/or stationary flight (i.e., hovering), and may operate for extended periods of time. The aerial platform 18 may include other configurations of the propulsion system 72 configured to utilize different placement and/or propulsion providing slow and/or stationary flight.

In some embodiments, the aerial platform 18 may include one or more power sources (not shown). The power sources may include one or more supplies of power to at least one or more electric loads on the aerial platform 18. The one or more power sources may include, but are not limited to electrical, solar, mechanical, or chemical energy. For example, in some embodiments, fuel may be used to power one or more components of the aerial platform 18. Additionally, one or more batteries may be included as one or more power sources for the aerial platform 18.

Referring to FIG. 2, the aerial platform 18 may also include one or more mounting systems 74. The mounting system 74 may be configured to attach the optical scanner 14 and/or the CDAS system 16 to the aerial platform 18 such that the effects of aerial dynamics and/or external forces for the operation of such systems may be minimized. In some embodiments, the one or more mounting systems 74 may position the optical source 28 and the optical sensor 32 at the separation distance l and angular orientation with respect to the baseline as specified by the pre-determine measurements as provided in detail above. The mounting system 74 may also maintain the separation distance l between the optical source 28 and the optical sensor 32, and the angular orientation with respect to the baseline within a small error tolerance (e.g., +/−0.01) during flight.

The mounting system 74 may be formed of materials with combinations of stiffness, weight and strength capable of mounting the optical scanner 14 and/or CDAS system 16 to the aerial platform 18 yet consume a small allotment of carrying capacity of the aerial platform 18. Generally, the mounting system 74 may position the optical scanner 14 or component of the optical scanner 14 in a rigid manner. In some embodiments, the mounting system 74 may include one or more supports configured to adjust the optical source 28 and/or optical sensor 32. Additionally, in some embodiments, the mounting system 74 may include one or more ties configured to secure wires between the optical source 28, the optical sensor 32, the CDAS system 16, the onboard data processing and transmission system 20, and/or the control system 22, although wireless embodiments are also contemplated.

FIG. 2 illustrates an exemplary embodiment of the aerial platform 18 wherein the propulsion system 72 is a quadcopter drone. The quadcopter drone may carry the optical source 28 and optical sensor 32 via the mounting system 74. The CDAS system 16 may be mounted an undercarriage of the aerial platform 18, for example. Wires may pass through and/or along the mounting system 74 to elements of the aerial scanning system 10 mounted to the aerial platform 18. In some embodiments, the mounting system 74 may support multiple CDAS systems 16 with each CDAS system 16 positioned in a different direction. In some embodiments, the mounting system 74 may include one or more rotating platforms controlled by a driver (e.g., servo, motor) configured to produce rotational motion. The rotating platform may support the CDAS system 16, for example, to provide scanning at a large field of view.

The piloting system 24 may be configured to provide navigation by a user located on the ground. In some embodiments, the piloting system 24 may be configured to provide navigation with the user located at a remote distance from the aerial platform 18. In some embodiments, the piloting system 24 may be configured to provide autonomous navigation of the aerial platform 18 using some form of artificial intelligence to plan and/or execute scanning and navigation processes.

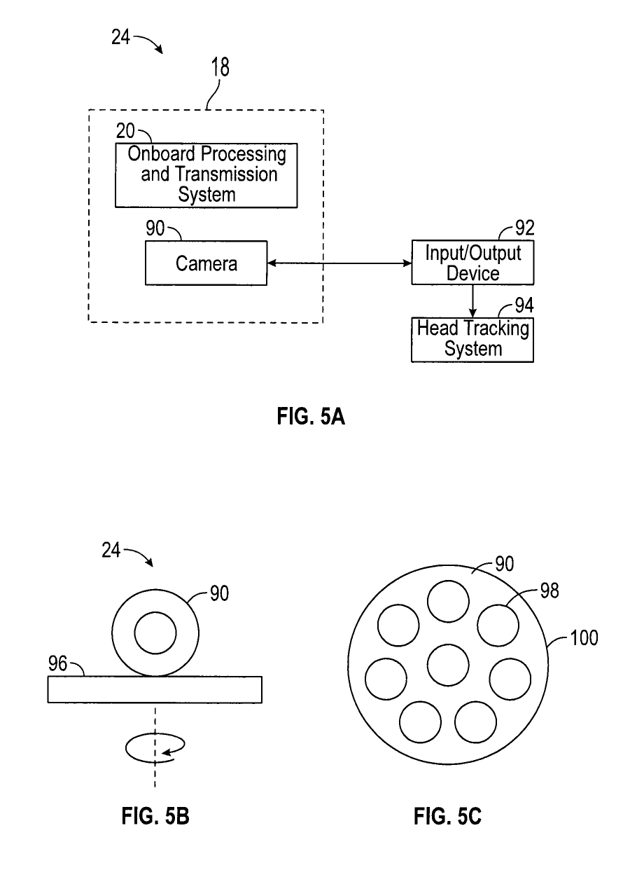

Referring to FIG. 5A, the piloting system 24 may generally include one or more cameras 90 and one or more input-output (I/O) devices 92. The one or more cameras 90 may be positioned on the aerial platform 18 to obtain data (e.g., video) and transmit the data to the one or more I/O devices 92. In some embodiments, the one or more cameras 90 may transmit the data via the communication link used for the onboard processing and transmission system 20. In some embodiments, the one or more cameras 90 may transmit the data via a separate communication link. Exemplary cameras may include, but are not limited to, stereoscopic camera, standard camera, 360 degree camera, and/or the like.

In some embodiments, the piloting system 24 may provide the user a virtual reality and/or augmented reality experience. For example, the I/O devices 92 may include virtual reality goggles. The virtual reality goggles may immerse the user within a three-dimensional environment representing navigation and/or scanning decisions as if the user was physically located on the aerial platform 18. Augmented reality goggles may superimpose data over or within the real-time three-dimensional environment. The data may include, but is not limited to, preliminary reconstructed images providing feedback on quality of the scanning process, battery life of the aerial scanning system 10, status indicators regarding health of systems of the aerial scanning system 10, navigational data and/or the like. Navigational data may include, but is not limited to, altitude, velocity, direction of flight, wind speed, location of potential obstacles, and/or the like. In some embodiments, the superimposed data may be presented to the user in the form of charts, numbers, gauges, and/or other methods for encoding and displaying such data, and may include, but is not limited to, panels and/or screens overlaying a visual field, organically positioned within the visual field, and/or the like.

In some embodiments, the I/O device 92 may provide a head tracking system 94. The head tracking system 94 may provide data on positioning and/or direction of the user's head such that different functionality may occur when the user rotates their head to the left, right, up or down, for example. The head tracking system 94 may communication with the camera 90 and/or the onboard data and transmission system 20 and direct the camera 90 to provide the user with a view corresponding the direction the user's head is positioned. For example, the user may be viewing a first field of view. If the user's head moves to the left, the I/O device 92 may communicate to the onboard processing and transmission system 20 or directly to the camera 90 to alter the viewing direction of the camera 90 and provide a second field of view. The second field of view may be similar to the positioning of the user's head in relation to the camera 90. In some embodiments, if the user's head moves in a particular direction (e.g., left), the I/O device 92 may provide the user an update on one or more status indicators, and/or the like.

FIGS. 5B and 5C illustrate exemplary piloting system 24 for use in the aerial scanning system 10. Referring to FIG. 5B, in some embodiments, the camera 90 in the piloting system 24 may be a stereoscopic camera mounted to a mechanical device 96 configured to rotate and/or vary direction of the camera 90. For example, the mechanical device 96 may include, but is not limited to, a gimbaled platform, a rotating platform, and/or the like. In some embodiments, the mechanical device 96 may be configured to position the camera 90 based on direction provided by the I/O device 92. Referring to FIG. 5C, in some embodiments, the camera 90 of the piloting system 24 may be a 360 degree camera or its equivalent that may collect and/or transmit visual environment data from one or more sub-cameras 98 positioned to capture the view in the direction desired by the user. In some embodiments, the camera 90 of the piloting system 24 may capture all views from all directions. The control system 22 may select which view of interest is to be delivered based on heading tracking, input via the I/O devices 92, and/or the like. Such selection by the control system 22 may be automatic (e.g., without human intervention) in some embodiments. The sub-cameras 98 may be positioned in a spherical housing 100. An exemplary 360 degree camera for use in the piloting system 24 may be the Ozo camera designed for filming virtual reality by Nokia, having a principal place of business in Helsinki, Finland. Other embodiments of the piloting system 24 including variations in sub-cameras 98, cameras 90 and/or I/O devices 92 are contemplated.

In some embodiments, the piloting system 24 may include autonomous navigation. For example, a user may provide the control system 22 on the aerial platform 18 with a definition and/or description of the structure 12. The control system 22 may autonomously determine and/or execute a scanning plan based on the definition and/or description of the structure 12. The definition and/or description of the structure 12 may include, but is not limited to, simplified model of the structure 12, geometric description of the real or effective outer surface of the structure 12, structural characteristics (e.g., solid mass, open grid of beam and/or supports, and/or the like), range of feature sizes of the structure 12, scanning path, flight path, targeting scanning accuracy, and/or the like. The user may provide the definition or description of the structure 12 in one or more formats such as, for example, spreadsheet file, CAD file, alphanumeric listing, and/or the like.

The control system 22 may use any known algorithm in the art to direct the aerial platform 18. Such algorithms may be modified for specific application or capabilities of the aerial platform 18. In some embodiments, one or more algorithms may be developed to aid in directing the aerial platform 18. Algorithms may provide a plan consisting of a sequence of one or more actions, both in navigation and in scanning, that the aerial scanning system 10 may execute in order to scan the structure 12. Additional hardware, firmware, or some combination, may convert actions into control signals needed to execute the plan.

In some embodiments, the control system 22 may then employ artificial intelligence (AI) resources to compute a plan for navigation around and scanning the structure 12. In some embodiments, the AI resources (i.e., hardware, firmware) may be solely positioned on the aerial platform 18. In some embodiments, one or more portions of the AI resources may be positioned at a distance from the aerial platform 18. In some embodiments, one or more portions of the AI resources may be cloud-based.

In addition to the definition and/or description of the structure 12, the AI resources may utilize data and/or pre-programmed knowledge regarding scanning, processing, and other systems present on the aerial scanning system 10 as inputs for planning algorithms. The AI resources may continuously monitor the environment, data from the CDAS system 16, and scanning quality of the optical scanner 14 to make real-time adjustments to ensure high-quality scanning and survival of the aerial platform 18 during flight.

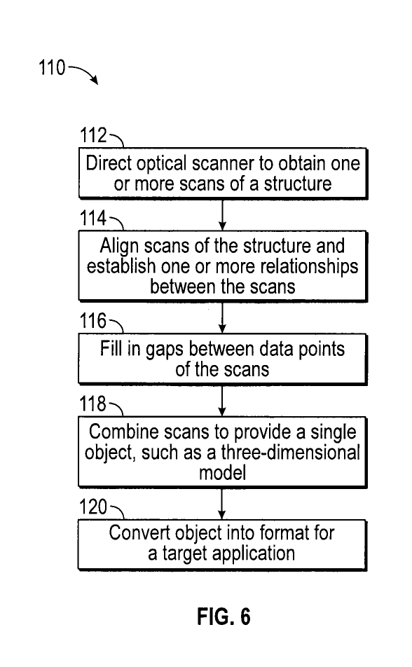

Referring to FIGS. 1 and 6, the control system 22 may be configured to provide data processing, control of the optical scanner 14 and CDAS system 16, piloting system 24, transmission of data to the collection station 40 and/or cloud for further processing, and/or the like.

In some embodiments, the control system 22 may determine the number of illumination patterns displayed per second, the illumination time for each pattern, and the time at which the optical scanner 14 samples and/or stores the output for further processing and/or transmission. The control system 22 may initiate a scanning operation for the optical scanner 14 by activating an image generator within the optical source 28. For example, for a DMD, the control system 22 may select which mirrors in the array may direct light towards the structure 12. In another example, for an LCD, the control system 22 may determine which liquid crystal cells may remain opaque and which liquid crystal cells may become transparent allowing for light to reach the structure 12. In another example, for an array of light emitters, the control system 22 may selectively turn on emitters that contribute to a desired optical pattern 30.

In some embodiments, the control system 22 may transmit a gating or timing signal to the optical sensor 32. Timing signals may trigger one or more events in the aerial scanning system 10 and may include, but are not limited to, a single pulse acting as a triggering mechanism, two or more bits encoding one or more messages, and/or the like. For example, a first timing signal may alert the optical sensor 32 to the release of a first optical pattern 30 and ready data collection circuitry with the optical sensor 32. The control system 22 may transmit a second pair of timing signals to deactivate the pattern generator within the optical source 28 and terminate sensing and collection by the optical sensor 32. The timing signals may ensure that the optical sensor 32 only collect light when the optical source 28 illuminates the structure 12 or a distinct portion of the structure 12, for example. Additionally, the timing signal may be configured such that the optical sensor 32 has sufficient time to collect the optical power needed to eventually provide precise and/or accurate data for reconstruction. In some embodiments, the timing signal may be configured such that data collected for a first optical pattern 30 may be transmitted and/or erased from the optical sensor 32 prior to collection of data from a second optical pattern 30.

The control system 22, in total or in part, may receive data from the CDAS system 16 and determine the existence and/or location of obstacles that impede the flight path of the aerial platform 18. The control system 22 may implement one of several existing algorithms in the art to process the data. The control system 22 may convert the output of the processing into one or more signals that exert control over the propulsion system 72 and/or navigation system 52 of the aerial platform 18. In some embodiments, the control system 22 may provide a user with information regarding obstacles and/or corrective action taken or needed, if applicable. The control system 22 may provide one or more control signals in formats for input to the propulsion system 72 and/or navigation system 52, with the format dependent on the aerial platform 18 in use. The user may receive signals in the form of, but not limited to, spatial representations, alarms, obstacle location and/or range data, corrections to the navigation path of the aerial platform 18, and/or the like. Such signals may allow for the user to determine appropriate corrective action needed and/or to correct the scanning process for a new navigational path.

In some embodiments, the control system 22 may compress data collected from the optical sensor 32. Data compression may minimize both memory and/or transmission capacity needed to store and/or transmit data. One or more data compression algorithms known within the art may be used to compress the data.

Additionally, the control system 22 may determine preliminary registration of such data to compensate for movement of the aerial platform 18 between captures by the optical sensor 32. Generally, in construction of a three-dimensional model of the structure 12, set of points contained within different captures of the structure 12 illuminated by the optical source 28 may be registered. The registration process may align the acquired data sets with a consistent frame of reference. Such reference may establish a relationship among sets of data and thus aid in fusing measurements into cohesion. For example, to produce a full three-dimensional file (e.g., CAD file) of the structure 12, the control system 22, onboard processing and transmission system 20 and/or the collection station 40 may conduct a process known as stitching (e.g., three-dimensional point cloud registration) to transform multiple smaller scans to a large scan of the structure 12. Each small scan may produce a three dimensional point cloud of the scan. Generally, as much as possible depth image of the structure 12 may be captures from one or more angles covering the surface of interest of the structure 12. Each sequenced pair of scan may have one or more overlap areas. Point clouds from each scan may be extracted. Three-dimensional registration may be performed on the extracted points. Generally, any algorithm may be used that minimizes the non-matched points such that matched points may be aligned.

Further, the control system 22 may use detection of movement of the aerial platform 18 to remove and/or reduce effects of such movement on any set of scans. Such removal and/or reduction may reduce processing needed and/or the modelling error produced by software. Detection of movement of the aerial platform 18 may include, but is not limited to, use of one or more accelerometers, gyroscopes, and/or the like.

In some embodiments, the control system 22 and/or the onboard processing and transmission system 20 may be configured to encapsulate data into a format used for transmission to the collection station 40 or other off-site receiver. For example, transmission may use protocols including, but not limited to, WiFi, 5G, 4G LTE, and/or the like. The control system 22 may deliver formatted and/or encapsulated data via the onboard data and transmission system 20. The onboard data and transmission system 20 may transmit the data to the collection station 40 or other off-site receiver.

The control system 22 and/or the collection station 40 may include processing software configure to construct one or more three-dimensional models of the structure 12 and/or express the model in one or more formats for use in modelling and design software. For example, the final file format for the model may include, but is not limited to, PDF, file formats supported by the program SolidWorks developed by Dassault Systemes having a principal place of business in France, and/or the like. It should be noted that algorithms within the processing software may be modified and/or specialized for systems in the aerial scanning system 10.

FIG. 6 illustrates an exemplary flow chart 110 for the control system 22, onboard processing and transmission system 20 and/or collection station 40 to perform to provide one or more three-dimensional models of the structure 12.

In some embodiments, prior to scanning, the optical source 28 and/or the optical sensor 32 may be calibrated. Camera-projector calibration process may determine intrinsic parameters of the optical sensor 32, intrinsic parameters of the optical source, stereo system extrinsic calibration parameters, and/or the like.

Intrinsic parameters of the optical sensor 32 and optical source 28 may include, but are not limited to, focal length, principal point offset, skew, radial distortion, tangential distortion, and/or the like. Such parameters may vary from the optical sensor 32 to the optical source 28 depending on model of use.

Stereo system extrinsic calibration parameters may include, but are not limited to, rotation matrix, translation vector, and/or the like. These two matrices may describe how the optical sensor 32 and the optical source 28 centers are located in relation to one another. For example, if each center is in the same location (i.e., theoretical as three-dimensional reconstruction is not viable), an identity rotation matrix may be determined and a zero translation vector.

Generally, calibration may be via a static method or interactive method. In the static method, parameters may be known during design and/or measured subsequent to fabrication. For example, focal length may be physically measured, distortion may be cancelled with careful designs, and/or the like. Extrinsic parameters may also be measured during the design stage. For example, both the optical sensor 32 and the optical source 28 may be adjusted in parallel. Then, the rotation matrix may be an identity. Each may be fixed in the same Y-axis with 5 CM different at the X-axis. As such, the translation matrix may also be known.

For calibration using the interactive method, all parameters may be considered unknown. The calibration process may then identify parameters depending on a previously known object. In using the interactive method, a non-square pattern may be used (e.g., a chess-board pattern). The dimensions of the pattern and may be known. Generally, the optical sensor 32 may capture an image of the pattern with the presence of the optical source 28 lighting on it. Images captured by the optical sensor 32 may be analyzed to detect the corners of the pattern. As the patterns dimensions are known, intrinsic parameters of the optical sensor 32 may be identified. To identify the parameters of the optical source 28, a transformation may be done from the space of the optical sensor 32 to the space of the optical source 28. This transformation may be done using the pattern. For example, the pattern projected by the optical source 28 may be decoded and matched pairs between the optical sensor 32 and the optical source 28 may be identified. Using a homograph transform, the transformation may move from the space of the optical sensor 32 to the space of the optical source 28. As such, an artificial image may identify how the optical source 28 sees the pattern. Intrinsic parameters of the optical source 28 may be identified similar to the intrinsic parameters of the optical sensor 32. Once the optical sensor 32 and the optical source 28 are calibrated, translation and rotation between the optical sensor 32 and the optical source 28 may be identified using matched points, and extrinsic parameters of the optical source 28 may then be identified using a simple linear system of equations.

In some embodiments, a hybrid method using the static calibration and interactive calibration may be used. For example, if focal length is 100% known, then this number may be used in the interactive method to solve for other parameters. Additional calibration methods are further described in the article entitled, Simple, Accurate, and Robust Projector-Camera Calibration by Daniel Moreno and Gabriel Taubin, Brown University, School of Engineering, which is hereby incorporated by reference in its entirety.

In a step 112, the optical scanner 14 may be directed to scan the structure 12 and obtain data (e.g., images) of the structure 12. In some embodiments, scanning each part of the structure 12 multiple times may provide potential for increased accuracy and/or precision. A larger structure 12 may need the optical source 28 to illuminate portions of the structure 12 multiple times and/or conduct a set of scans for each portion of the structure 12 to be capable of recoding data on the entire structure 12. Additionally, the optical source 28 may illuminate portions of the structure 12 multiple times and/or conduct a set of scans for each portion of the structure 12 at same and/or similar angles and different angles. Exemplary optical patterns 30 and measurement techniques may be found in the article by Jason Geng, Structured-light 3D Surface Imaging: a tutorial, Advances in Optics and Photonics 3, 128-160 (2011), which is hereby incorporated by reference in its entirety.

The calibrated system may be able to identify X, Y and Z of any points relative to the frame of the optical sensor 32 which originates in the center of the lens of the optical sensor 32. This coordinator may be expressed in real world units (e.g., CM). However, these points are expressed relatively to the location of the optical sensor 32. In some embodiments, a reference frame may be provided. The reference frame may provide guidance on location of the aerial platform 18 relative to the reference frame. For example, using overlap of scans, a first scan may be performed with a reference corner and/or one or more additional reference points visible to the optical scanner 14. The position of the optical scanner 14 may be determined. A second scan may then be performed with the second scan overlapping at least a portion of the first scan. With such overlap, the first scan and the second scan share at least one point at which position of optical scanner 14 during the second scan may be determined using geometrical computations.

In a step 114, the scans may be aligned via one or more registration processes. The one or more registration processes may align data sets, from a single section or among adjacent scanned section, with a consistent frame of reference as described in further detail herein. The registration process may establish relationships among the sets aiding in fusing measurements into a cohesive whole. During the step 114, movement of the aerial platform 18 (e.g., lateral, longitudinal, angular movement) occurring between instances of data collection by the optical sensor 32 may be accounted for. For example, movement data related to the aerial platform 18 may be collected in addition to raw or pre-processed data from the optical sensor 32. In some embodiments, registration performed in the collection station 40 may complement any pre-processing or registration determination performed in the control system 22. The registration process may also consider and/or account for overlap in scans of neighbouring sections of the structure 12 in establishing a common frame of reference. For example, allowing adjacent scan segments to overlap may provide the registration algorithm with additional information improving accuracy and/or precision of the processing software in constructing a cohesive model from individual portions.

In a step 116, gaps between data points may be accounted for and filled in. Gaps may arise from the discrete nature of either the optical source 28 or the optical sensor 32 (e.g., pixilated sensors). Such gaps may be generalized, or filled in to smooth out the visual representation. The filling may be based on deep learning and/or AI algorithms, which may incorporate a learned process after several scans of the structure 12, for example. Such learning processes may aid the algorithm in estimation of shape of each portion of the structure 12 and fill in gaps.

In a step 118, outputs of previous steps may be combined to provide a single object such as the three-dimensional model. In some embodiments, several iterations of steps 116 and 118 may be performed to provide the single object. In a step 120, the single object may be converted into a format suitable for a target application. Such target application may include manufacturing, engineering and design applications.

The aerial scanning system and methods disclosed and claimed herein are well adapted to carry out the objects and to attain the advantages mentioned herein, as well as those inherent in the invention. While exemplary embodiments of the concepts disclosed herein have been described, it will be understood that numerous changes may be made which will readily suggest themselves to those skilled in the art and which are accomplished within the spirit of the inventive concepts disclosed and claimed herein.

What is claimed is:

1. An aerial scanning system for creating a model of a structure, comprising:
an aerial platform configured to follow a flight path of movement about the structure;
an optical scanner comprising:
at least one optical source configured to project at least one optical pattern on the surface of the structure; and
at least one optical sensor configured to record data related to the at least one optical pattern projected on the surface of the structure;
a piloting system providing the flight path of movement about the structure to the aerial platform; and,
a control system executing processing software reading:
data corresponding to the at least one surface of the structure; and,
data corresponding to movement of the aerial platform about the structure;
wherein the processing software executed by the control system determines a three dimensional model of the structure using data corresponding to the surface of the structure and data corresponding to movement of the aerial platform about the structure.

2. The aerial scanning system of claim 1, wherein a single optical pattern is projected by the at least one optical source, and recorded by the optical sensor to determine a frame of information using a single shot algorithm.

3. The aerial scanning system of claim 1, wherein the at least one optical pattern includes a series of optical patterns.

4. The aerial scanning system of claim 3, wherein the aerial platform is configured to remain static during projection of the series of optical patterns.

5. The aerial scanning system of claim 1, wherein the optical source and the optical sensor are rigidly mounted on the aerial platform such that the optical source and optical sensor remain in a static geometric relationship.

6. The aerial scanning system of claim 1, wherein data obtained from the optical sensor is combined with known distance between the optical source and the optical sensor, angular orientation of the optical source and the optical sensor and content of the optical pattern to determine the model of the structure.

7. The aerial scanning system of claim 1, wherein the optical scanner includes at least one LiDAR system.

8. The aerial scanning system of claim 7, wherein the optical scanner includes at least one LiDAR system positioned on the aerial platform for horizontal scanning and at least one LiDAR system positioned on the aerial platform for vertical scanning wherein each LiDAR system captures horizontal resolution.

9. The aerial scanning system of claim 1, further comprising a collision detection and avoidance system including an environment mapping system configured to obtain data regarding at least one object in an environment surrounding the aerial platform;
wherein the control system executes processing software reading data corresponding to at least one object in the environment around the aerial platform and determines a second flight path for the piloting system to avoid the at least one object.

10. The aerial scanning system of claim 1, wherein the object in the environment about the aerial platform is the structure and the control system determines proximity of the aerial platform to the structure.

11. The aerial scanning system of claim 1, wherein the piloting system is autonomous.

12. The aerial scanning system of claim 1, wherein the piloting system is directed by a user.

13. The aerial scanning system of claim 1, wherein data corresponding to the at least one surface of the structure includes at least two scans of at least one optical pattern.

14. The aerial scanning system of claim 13, wherein the scans are aligned via a registration process such that a consistent frame of reference between each scan is established.

15. The aerial scanning system of claim 14, wherein data corresponding to movement of the aerial platform about the structure is used in determination of the consistent frame of reference between each scan.

16. The aerial scanning system of claim 1, wherein the piloting system includes a camera and an I/O device, the camera is positioned on the aerial platform and obtains data of surrounding environment about the aerial platform and transmits the data to the I/O device.

17. The aerial scanning system of claim 16, wherein the I/O device is a virtual reality device providing a three-dimensional environment representation based on the data obtained from the camera of the piloting system.

18. An automated method of constructing a three-dimensional model of a structure, comprising:
receiving data sets related to a series of optical patterns projected onto the structure;
receiving data related to one or more movements of an aerial platform traveling on a flight path;
determining alignment of the data sets, wherein such determination uses data related to one or more movements of the aerial platform on the flight path; and,
combining data sets to provide the three-dimensional model of the structure.

19. The automated method of constructing a three-dimensional model of a structure of claim 18, further comprising the step of receiving data related to one or more objects in a flight path of an aerial platform; and altering the flight path of the aerial platform to avoid the one or more objects.

20. An autonomous, real-time aerial scanning system, comprising:
an aerial platform having a propulsion system including at least four rotors;
an autonomous piloting system having a pre-defined flight path about a structure and configured to direct the at least four rotors of the aerial platform;
a collision detection and avoidance system configured to identify at least one object within the flight path;
an optical scanner including an optical source and an optical sensor, the optical source configured to provide a series of optical patterns on at least one surface of the structure for detection by the optical sensor;
a control system executing processing software reading:
data corresponding to the at least one surface of the structure obtained by the optical sensor;
data corresponding to the at least one object within the flight path; and,
data corresponding to movement of the aerial platform about the structure;
wherein the processing software executed by the control system determines a second flight path based on the at least one object; and
wherein the processing software transmit data corresponding to the surface of the structure and data corresponding to movement of the aerial platform about the structure to a collection station.
